(19) United States
(12) Patent Application Publication
(10) Pub. No.: US 2012/0172054 A1
(43) Pub. Date: Jul. 5, 2012

(54) SYSTEM AND METHOD FOR COOPERATIVE POSITIONING

(75) Inventors: Deric W. WATERS, Dallas, TX (US); Tarkesh PANDE, Dallas, TX (US); Jaiganesh BALAKRISHNAN, Bangalore (IN)

(73) Assignee: TEXAS INSTRUMENTS INCORPORATED, Dallas, TX (US)

(21) Appl. No.: 13/327,052

(22) Filed: Dec. 15, 2011

Related U.S. Application Data
(60) Provisional application No. 61/430,025, filed on Jan. 5, 2011.
(60) Provisional application No. 61/451,677, filed on Mar. 11, 2011.

(51) Int. Cl. H04W 24/00

(52) U.S. Cl. 455/456.1

(57) ABSTRACT

Apparatus and method for cooperatively positioning a mobile wireless device. In one embodiment a mobile wireless device includes a navigation satellite receiver, a WLAN transceiver, and a cooperative positioning system. The navigation satellite receiver is configured to receive positioning signals from positioning satellites. The cooperative positioning system is configured to receive positioning measurements from a cooperating mobile wireless device via the WLAN transceiver. The received positioning measurements are derived from satellite positioning signals received by the cooperating mobile wireless device. The cooperative positioning system is also configured to determine a position of the mobile wireless device based on the positioning measurements received from the cooperating mobile wireless device, positioning measurements provided by the navigation satellite receiver, and a focal measurement that is a function of at least one of the position and the clock bias of both the mobile wireless device and the cooperating mobile wireless device.

### CROSS-REFERENCE TO RELATED APPLICATION

The present application claims priority to U.S. Provisional Patent Application No. 61/430,025, filed on Jan. 5, 2011 (Attorney Docket No. TI-70163PS) and to U.S. Provisional Patent Application No. 61/451,677, filed on Mar. 11, 2011 (Attorney Docket No. TI-70163PS1); both of which are hereby incorporated herein by reference in their entirety.

### BACKGROUND

As mobile devices proliferate, the demand for services tailored to device location also increases. Location based services depend on positioning systems to determine device location. Satellite based position systems, such as the global positioning system (GPS), GLONASS, and Galileo can provide high accuracy, but require a clear line of sight between the satellites and the mobile device to provide a position determination. Consequently, satellite positioning systems are largely ineffective for positioning of mobile devices that lack sufficient satellite visibility to determine a location. For example, if obstacles limit visibility of a mobile device to fewer than four satellites, then the mobile device may be unable to determine its position based solely on the visible satellites.

### SUMMARY

Apparatus and method for cooperatively positioning a mobile wireless device are disclosed herein. In one embodiment a mobile wireless device includes a navigation satellite receiver, a wireless local area network (WLAN) transceiver, and a cooperative positioning system. The navigation satellite receiver is configured to receive positioning signals from positioning satellites. The cooperative positioning system is configured to receive positioning measurements from a cooperating mobile wireless device via the WLAN transceiver. The received positioning measurements are derived from satellite positioning signals received by the cooperating mobile wireless device. The cooperative positioning system is also configured to determine a position of the mobile wireless device based on the positioning measurements received from the cooperating mobile wireless device, positioning measurements provided by the navigation satellite receiver, and a focal measurement that is a function of at least one of the position and the clock bias of both the mobile wireless device and the cooperating mobile wireless device.

In another embodiment, a method includes receiving, by a first mobile wireless device, positioning signals transmitted by positioning satellites. Positioning measurements are derived from the positioning signals. Positioning measurements from a second mobile wireless device are received via a wireless local area network. A position of the first mobile wireless device is determined based on the positioning measurements from the second mobile wireless device, the positioning measurements derived by the first mobile wireless device, and a focal measurement that is a function of at least one of the position and the clock bias of both the first mobile wireless device and the second mobile wireless device.

In yet another embodiment, a wireless device positioning system includes a processor configured to receive satellite positioning measurements from a host wireless device that includes the processor. The processor is also configured to receive satellite positioning measurements from a cooperating wireless device. The processor is further configured to determine a position of the host wireless device based on the positioning measurements from the cooperating mobile wireless device, the positioning measurements from the host wireless device, and a focal measurement that is a function of at least one of the position and the clock bias of both the host wireless device and the cooperating mobile wireless device.

### BRIEF DESCRIPTION OF THE DRAWINGS

For a detailed description of exemplary embodiments of the invention, reference will now be made to the accompanying drawings in which:

FIG. 1 shows a block diagram of a system for using cooperative satellite positioning to determine the position of a wireless device in accordance with various embodiments;

FIG. 2 shows a block diagram of a mobile device configured to perform cooperative satellite positioning in accordance with various embodiments;

FIG. 3 shows a message exchange between wireless devices for determining time of flight and clock offset between two wireless devices in accordance with various embodiments; and

FIG. 4 shows a flow diagram for a method for performing cooperative satellite positioning in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. Further, the term “software” includes any executable code capable of running on a processor, regard less of the media used to store the software. Thus, code stored in memory (e.g., non-volatile memory), and sometimes referred to as “embedded firmware,” is included within the definition of software. The recitation “based on” is intended to mean “based at least in part on.” Therefore, if X is based on Y, X may be based on Y and any number of other factors.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In operational scenarios where a mobile wireless device is unable to view sufficient positioning satellites to accurately determine the location of the device, a cooperating device may be able to share satellite positioning information that allows the mobile wireless device to determine its location. Embodiments of the present disclosure share satellite positioning information via a wireless local area network. Through cooperative positioning, as disclosed herein, two mobile devices with “weak” measurement data (e.g., able to view fewer than four satellites) can cooperate to improve their navigation or positioning accuracy and reliability. Similarly, a mobile device with “stronger” measurement data (e.g., able to view at least four satellites) can help a device with “weak” measurement data to improve its navigation or positioning accuracy and reliability. Thus, embodiments allow a mobile device to compute its global navigation satellite system (GNSS) location in harsh environments where existing GNSS receivers alone fail.

Embodiments disclosed herein, employ measurements made in the mobile devices other than GNSS pseudorange and Doppler for position determination. For example, if the mobile devices include a speed estimator, a bearing estimator, or an altimeter then such corresponding measurements may be employed to enable improved positioning performance. Embodiments of the positioning system disclosed herein employ at least one “focal” measurement that is a function of the positions and/or clock biases of both devices. Examples of such focal measurements are distance between devices, relative altitude, relative clock bias, and relative bearing.

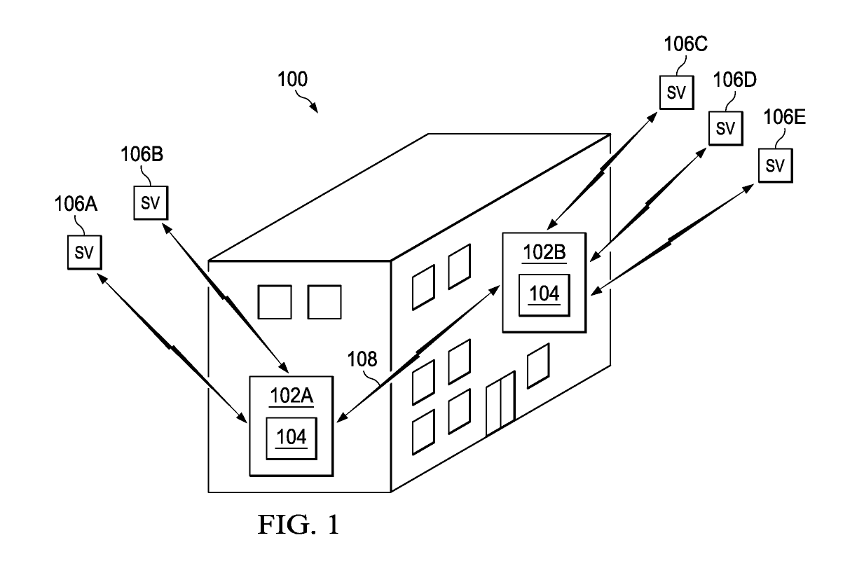

FIG. 1 shows a block diagram of a system 100 for using cooperative satellite positioning to determine the position of a wireless device in accordance with various embodiments. The system 100 includes two mobile wireless devices 102A, 102B (instances of mobile wireless device 102) and a plurality of positioning satellites 106 (designated 106A-106E). The mobile wireless device 102A is disposed within view of positioning satellites 106A and 106B. The mobile wireless device 102B is disposed within view of positioning satellites 106C, 106D, and 106E. For example, the mobile wireless device 102A may be disposed to one side of a structure and the mobile wireless device 102B disposed to a different side of the structure, where the structure obstructs the view of the mobile wireless devices 102A, 102B with regard to the satellites 106.

The mobile wireless devices 102 may be a mobile telephones, cameras, gaming systems, or other mobile wireless devices that include satellite positioning and wireless networking. In some embodiments, one of the wireless devices 102 may be non-mobile or disposed at a fixed location. The mobile wireless devices 102 are configured to communicate via a wireless local area network (WLAN) 108. The WLAN 108 may be a network in accordance with the IEEE 802.11 specification (e.g., IEEE 802.11(v)).

While a limited number of mobile wireless devices 102 and positioning satellites 106 are shown as a matter of concision, embodiments of the system 100 may include any number of mobile wireless devices 102 and positioning satellites 106. The positioning satellites 106 may be navigation satellites of the Global Positioning System (GPS), the Global Navigation Satellite System (GLONASS), or another satellite navigation system. Any number of additional devices not shown in FIG. 1 may be connected to and/or accessible via the WLAN 108. For example, access points, servers, etc. may be connected to the WLAN 108 directly or through a different network (e.g., a wide area network, the internet, etc.) and accessible to the mobile wireless devices 102.

Because neither of the mobile wireless devices 102 is able to view at least four positioning satellites 106, neither device 102 is able to individually determine its location. Each of the mobile wireless devices 102 includes a cooperative positioning system 104 that shares satellite positioning measurements and information for deriving focal measurements with a cooperating wireless device 102. Exemplary focal measurements include distance between devices, relative altitude, relative clock bias, and relative bearing. Using the shared measurements, each wireless device 102A, 102B is able to compute its position. Measurements may be bidirectionally or unidirectionally shared. That is, device 102B may provide measurements to device 102A and/or device 102A may provide measurements to device 102B.

The mobile wireless devices 102A, 102B may share the positioning measurements via the WLAN 108. In some embodiments, one of the wireless devices 102 may operate as a soft access point allowing the wireless devices 102A, 102B to communicate directly. In some embodiments, each wireless device 102A, 102B may provide the positioning measurements to a server on the WLAN 108, and in turn, the server may provide the positioning measurements to the other mobile wireless device 102A, 102B.

In other operational scenarios, the wireless device 102A may be positioned to view enough satellites 106 to determine its location, while the device 102B is unable to view sufficient satellites for location determination. In such a scenario, positioning measurements shared by the mobile wireless device 102A allow the mobile wireless device 102B to determine its location. In some embodiments of the system 100 the devices 102 may also exchange the media access control (MAC) address for one or more access points of the WLAN 108 known to the device 102. Received signal strength indicator (RSSI) values measured for each MAC address may also be exchanged.

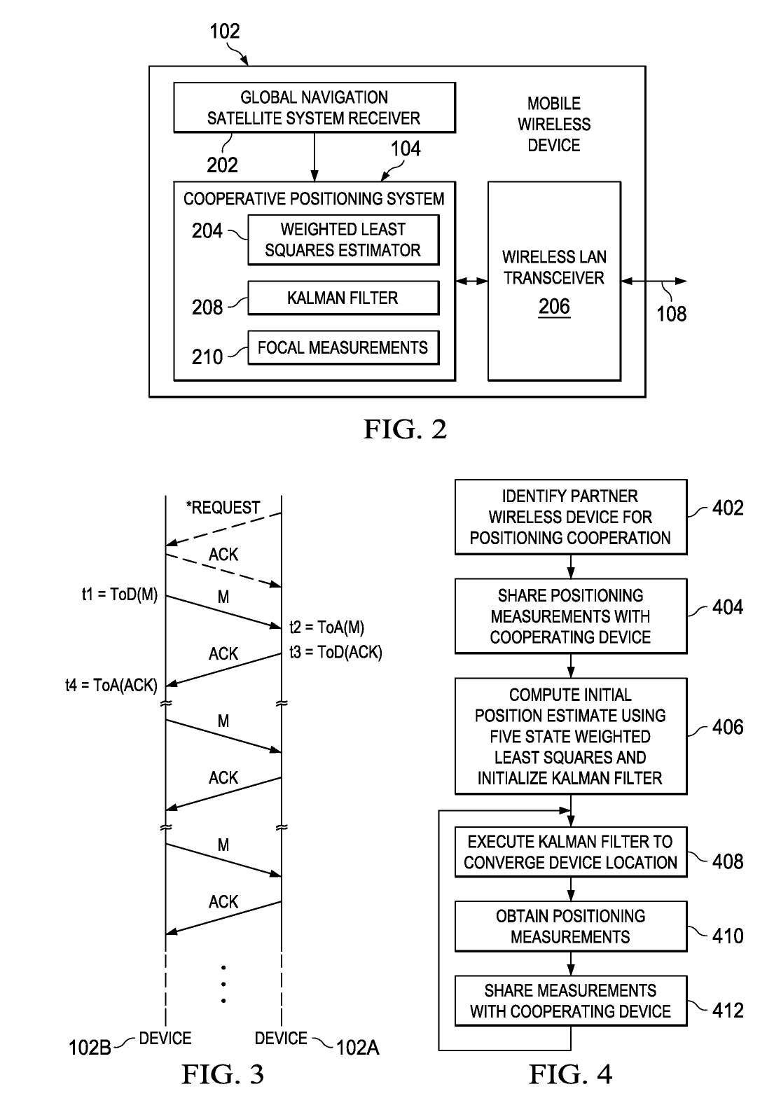

FIG. 2 shows a block diagram of a mobile wireless device 102 configured to perform cooperative satellite positioning in accordance with various embodiments. The mobile wireless device 102 includes a GNSS receiver 202, a WLAN transceiver 206, and the cooperative positioning system 104. The GNSS receiver 202 includes circuitry and logic for receiving signals transmitted by the positioning satellites 106, deriving positioning measurement values from the received signals, and determining the location of the receiver 202 based on the positioning measurements when sufficient satellites 106 are in view. The GNSS receiver 202 provides positioning measurements to the cooperative positioning system 104. The GNSS receiver 202 may be a GPS receiver, a GLONASS receiver, etc.

The WLAN transceiver 206 includes circuitry and logic for communicating via the WLAN 108 (e.g., an IEEE 802.11 compliant WLAN). The mobile wireless device 102 may transmit and/or receive positioning measurements usable by the cooperative positioning system 104 via the WLAN transceiver 206.

The cooperative positioning system 104 includes circuitry and logic that determines the position of the mobile wireless device 102 based on the satellite positioning measurement values provided by the GNSS receiver 202 and satellite positioning measurement values provided by a different mobile wireless device 102 via the WLAN 108, and one or more focal measurement values 210 that are a function of both the mobile wireless device 102 and a cooperating mobile wireless device.

The cooperative positioning system 104 includes a 5-state weighted least squares (WLS) estimator 204 and a Kalman filter 208. The 5-state weighted least squares estimator 204 provides a coarse initial estimate of the location of the mobile wireless device 102 (accurate within about 500 meters or so) for use by the Kalman filter 208. The Kalman filter 208 refines the initial estimate to more accurately determine the location of the mobile wireless device 102. In some embodiments, the 5-state WLS estimator 204 makes the assumption that the mobile wireless device 102 and a cooperating mobile wireless device are at the same location (x_{A}=x_{B}, y_{A}=y_{B}, zₐ=z_{B}). While this assumption may be incorrect, the devices 102 are close enough that the cooperative positioning system 104 can produce an estimate of the location of the mobile wireless device 102. Furthermore, the velocity or clock drift states do not need to be estimated. Initializing these to zero is sufficient, because the Kalman filter can refine the estimate based on the initial estimate.

The cooperative positioning system 104 employs various measurements from the mobile wireless device 102 and a cooperating mobile wireless device to determine position. The measurements may include: pseudorange values from one or both mobile wireless devices 102, Doppler frequency from one or both mobile wireless devices 102, a speed estimate for one or both of the mobile wireless devices 102, a velocity estimate for one or both mobile wireless devices 102, distance between the mobile wireless devices 102, relative clock bias between the mobile wireless devices 102, relative bearing between the mobile wireless devices 102, and relative altitude between the mobile wireless devices 102. The distance, clock bias, bearing and altitude values are termed focal measurements because these values are a function of the position and/or clock bias of both mobile wireless devices 102. Embodiments of the cooperative positioning system 104 employ at least one focal measurement value to cooperatively determine the location of the mobile wireless device 102.

A system of equations solved by the Kalman filter 208 is shown below. Not all measurements may be available to the cooperative positioning system 104 and all are not required as long as the system is resolvable. The pseudorange and Doppler measurement equations can be repeated for all satellites, and each mobile wireless device 102 need not be in view of a particular satellite. The system of equations can be expanded to incorporate more than two mobile wireless devices 102. In the system of equations, there are a total of 16 unknowns to be resolved. Each row in the matrix is a representative equation for a particular kind of measurement. The system of equations can be simplified in a number of ways. For example, if velocities are not applicable then the number of unknowns is cut in half by removing velocity and clock drift states. Also, not every kind of measurement may be available. Further, there may be pseudorange and/or pseudorange rate measurements from multiple satellites even though the equation is written as though each device 102 derives measurements from only one satellite. Each device 102 may or may not obtain measurements from the same satellites.

$${[ \begin{matrix}{ρ}_{1}^{A} \\ {\dot{ρ}}_{1}^{A} \\ {ρ}_{1}^{B} \\ {\dot{ρ}}_{1}^{B} \\ d \\ {S}_{A} \\ {S}_{B} \\ {\dot{n}}_{A} \\ {\dot{e}}_{A} \\ {\dot{u}}_{A} \\ {\dot{n}}_{B} \\ {\dot{e}}_{B} \\ {\dot{u}}_{B}\end{matrix} ]}_{{[ Δ a ]}_{[ Δ b ]}} = {[ \begin{matrix}{a}_{x} & {a}_{y} & {a}_{z} & 1 & 0 & 0 & 0 & 0 & 0 & 0 & 0 & 0 & 0 & 0 & 0 & 0 \\ {\tilde{a}}_{x} & {\tilde{a}}_{y} & {\tilde{a}}_{z} & 0 & {a}_{x} & {a}_{y} & {a}_{z} & 1 & 0 & 0 & 0 & 0 & 0 & 0 & 0 & 0 \\ 0 & 0 & 0 & 0 & 0 & 0 & 0 & 0 & {b}_{x} & {b}_{y} & {b}_{z} & 1 & 0 & 0 & 0 & 0 \\ 0 & 0 & 0 & 0 & 0 & 0 & 0 & 0 & {\tilde{b}}_{x} & {\tilde{b}}_{y} & {\tilde{b}}_{z} & 0 & {b}_{x} & {b}_{y} & {b}_{z} & 1 \\ {d}_{x} & {d}_{y} & {d}_{z} & 0 & 0 & 0 & 0 & 0 & - {d}_{x} & - {d}_{y} & - {d}_{y} & 0 & 0 & 0 & 0 & 0 \\ 0 & 0 & 0 & 0 & {c}_{A , 1} & {c}_{A , 2} & {c}_{A , 2} & 0 & 0 & 0 & 0 & 0 & 0 & 0 & 0 & 0 \\ 0 & 0 & 0 & 0 & 0 & 0 & 0 & 0 & 0 & 0 & 0 & 0 & {c}_{B , 1} & {C}_{B , 2} & {c}_{B , 3} & 0 \\ 0 & 0 & 0 & 0 & {c}_{A , 11} & {c}_{A , 12} & {c}_{A , 13} & 0 & 0 & 0 & 0 & 0 & 0 & 0 & 0 & 0 \\ 0 & 0 & 0 & 0 & {c}_{A . , 21} & {c}_{A , 22} & {c}_{A , 23} & 0 & 0 & 0 & 0 & 0 & 0 & 0 & 0 & 0 \\ 0 & 0 & 0 & 0 & {c}_{A , 31} & {c}_{A , 32} & {c}_{A , 33} & 0 & 0 & 0 & 0 & 0 & 0 & 0 & 0 & 0 \\ 0 & 0 & 0 & 0 & 0 & 0 & 0 & 0 & 0 & 0 & 0 & 0 & {c}_{B , 11} & {c}_{B , 12} & {c}_{b , 13} & 0 \\ 0 & 0 & 0 & 0 & 0 & 0 & 0 & 0 & 0 & 0 & 0 & 0 & {c}_{B , 21} & {c}_{B , 22} & {c}_{B , 23} & 0 \\ 0 & 0 & 0 & 0 & 0 & 0 & 0 & 0 & 0 & 0 & 0 & 0 & {c}_{B , 31} & {c}_{B , 32} & {c}_{B , 33} & 0\end{matrix} ]}_{{[ \begin{matrix}\frac{{x}_{A}}{{n}_{A}} & \frac{{y}_{A}}{{n}_{A}} & \frac{{z}_{A}}{{n}_{A}} & 0 & 0 & 0 & 0 & 0 & - \frac{{x}_{B}}{{n}_{B}} & - \frac{{y}_{B}}{{n}_{B}} & - \frac{{z}_{B}}{{n}_{B}} & 0 & 0 & 0 & 0 & 0\end{matrix} ]}_{[ \begin{matrix}0 & 0 & 0 & - 1 & 0 & 0 & 0 & 0 & 0 & 0 & 0 & 1 & 0 & 0 & 0 & 0\end{matrix} ]}} [ \begin{matrix}{x}_{A} \\ {y}_{A} \\ {z}_{A} \\ - {b}_{A} \\ {\dot{x}}_{A} \\ {\dot{y}}_{A} \\ {\dot{z}}_{A} \\ - {\dot{b}}_{A} \\ {x}_{B} \\ {y}_{B} \\ {z}_{B} \\ - {b}_{B} \\ {x}_{B} \\ {\dot{y}}_{B} \\ {\dot{z}}_{B} \\ - {\dot{b}}_{B}\end{matrix} ] + {v}_{noise}$$

ρ₁^{A} and ρ₁^{B} are pseudorange measurements computed by the GNSS receivers 202 of the cooperating mobile wireless devices 102 where:
a=└aₓ a_{y} a_{z}┘ defines a unit vector from the first mobile wireless device (e.g. device 102A) to the GNSS satellite.
└bₓ b_{y} b_{z}┘ defines a unit vector from the second mobile wireless device (e.g. device 102B) to the GNSS satellite.

\dot{ρ}₁^{A} and \dot{ρ}₁^{B} are Doppler frequency measurements computed by the GNSS receivers 202 of the cooperating mobile wireless devices 102 where:

$$[ {\tilde{a}}_{x} {\tilde{a}}_{y} {\tilde{a}}_{z} ] = \frac{\tilde{v} - ( \tilde{v} \cdot {a}^{T} ) a}{r}$$

$$\tilde{v} = [ \dot{x} - {\dot{S}}_{x , 1} \dot{y} - {\dot{S}}_{y , 1} \dot{z} - {\dot{S}}_{z , 1} ]$$

$$r = \sqrt{{( x - {S}_{x , 1} )}^{2} + {( y - {S}_{y , 1} )}^{2} + {( z - {S}_{z , 1} )}^{2}} \\ [ {\dot{S}}_{x , 1} {\dot{S}}_{y , 1} {\dot{S}}_{z , 1} ] is satellite velocity \\ [ {\dot{S}}_{x , 1} {\dot{S}}_{y , 1} {\dot{S}}_{z , 1} ] is satellite position$$

$$a = [ \frac{x - {S}_{x , 1}}{r} \frac{y - {S}_{y , 1}}{r} \frac{z - {S}_{z , 1}}{r} ]$$

[\tilde{b}ₓ \tilde{b}_{y} \tilde{b}_{z}] is defined in the same manner as └ãₓ ã_{y} ã_{z}┘ using the position and velocity of the second wireless device 102.

d is a distance measurement computed by the cooperative positioning system 104, where:
└dₓ d_{y} d_{z}┘ defines a unit vector from the mobile wireless device 102A to the mobile wireless device 102B, and

$${d}_{x} = \frac{{x}_{A} - {x}_{B}}{\sqrt{{( {x}_{A} - {x}_{B} )}^{2} + {( {y}_{A} - {y}_{B} )}^{2} + {( {z}_{A} - {z}_{B} )}^{2}}}$$

$${d}_{y} = \frac{{y}_{A} - {y}_{B}}{\sqrt{{( {x}_{A} - {x}_{B} )}^{2} + {( {y}_{A} - {y}_{B} )}^{2} + {( {z}_{A} - {z}_{B} )}^{2}}}$$

$${d}_{z} = \frac{{z}_{A} - {z}_{B}}{\sqrt{{( {x}_{A} - {x}_{B} )}^{2} + {( {y}_{A} - {y}_{B} )}^{2} + {( {z}_{A} - {z}_{B} )}^{2}}}$$

s_{A} and s_{B} are speed measurements for each of the pair of cooperating mobile wireless devices 102. For mobile wireless device 102A:

$${S}_{A} = \sqrt{{\dot{n}}_{A}^{2} + {\dot{e}}_{A}^{2} + {\dot{u}}_{A}^{2}} + v = \sqrt{{\dot{x}}_{A}^{2} + {\dot{y}}_{A}^{2} + {\dot{z}}_{z}^{2}} + v$$

$${C}_{A , j} = {c}_{A , 1 , j} \frac{{\dot{n}}_{A}}{\sqrt{{\dot{n}}_{A}^{2} + {\dot{e}}_{A}^{2} + {\dot{u}}_{A}^{2}}} + {c}_{A , 2 , j} \frac{{\dot{e}}_{A}}{\sqrt{{\dot{n}}_{A}^{2} + {\dot{e}}_{A}^{2} + {\dot{u}}_{A}^{2}}} + {c}_{A , 2 , j} \frac{{\dot{e}}_{A}}{\sqrt{{\dot{n}}_{A}^{2} + {\dot{e}}_{A}^{2} + {\dot{u}}_{A}^{2}}} \\$$

$$where [ \begin{matrix}{c}_{A , 11} & {c}_{A , 12} & {c}_{A , 13} \\ {c}_{A , 21} & {c}_{A , 22} & {c}_{A , 23} \\ {c}_{A , 31} & {c}_{A , 32} & {c}_{A , 33}\end{matrix} ] = [ \begin{matrix}- sin ( φ ) cos ( λ ) & - sin ( φ ) sin ( λ ) & cos ( φ ) \\ - sin ( λ ) & cos ( λ ) & 0 \\ - cos ( φ ) sin ( λ ) & - cos ( φ ) cos ( λ ) & - sin ( φ )\end{matrix} ]$$

or alternatively:

$${c}_{A , 1} = \frac{{\dot{x}}_{A}}{\sqrt{{\dot{x}}_{A}^{2} + {\dot{y}}_{A}^{2} + {\dot{z}}_{A}^{2}}}$$

$${c}_{A , 2} = \frac{{\dot{y}}_{A}}{\sqrt{{\dot{x}}_{A}^{2} + {\dot{y}}_{A}^{2} + {\dot{z}}_{A}^{2}}}$$

$${c}_{A , 3} = \frac{{\dot{z}}_{A}}{\sqrt{{\dot{x}}_{A}^{2} + {\dot{y}}_{A}^{2} + {\dot{z}}_{A}^{2}}}$$

The speed measurement for mobile wireless device 102B is similarly derived. If only a horizontal speed is available, then c₃ⱼ=0, and s_{A}=\sqrt{\dot{n}_{A}²+ė_{A}²}+v. If only a vertical speed is available, then c₁ⱼ=0, c₂ⱼ=0, and s_{A}=\sqrt{\dot{u}_{A}²}+v.

Mobile wireless device velocity measurements are converted from Earth-Centered, Earth-Fixed (ECEF) to north, east & up coordinate frame as:

$$[ \begin{matrix}{\dot{n}}_{A} \\ {\dot{e}}_{A} \\ {\dot{u}}_{A}\end{matrix} ] = C [ \begin{matrix}{\dot{x}}_{A} \\ {\dot{y}}_{A} \\ {\dot{z}}_{A}\end{matrix} ] ,$$

where:
C is a 3×3 coordinate transformation matrix (from ECEF to local navigation frame).

$$C = [ \begin{matrix}{c}_{11} & {c}_{12} & {c}_{13} \\ {c}_{21} & {c}_{22} & {c}_{23} \\ {c}_{31} & {c}_{32} & {c}_{33}\end{matrix} ] = [ \begin{matrix}- sin ( φ ) cos ( λ ) & - sin ( φ ) sin ( λ ) & cos ( φ ) \\ - sin ( λ ) & cos ( λ ) & 0 \\ - cos ( φ ) sin ( λ ) & - cos ( φ ) cos ( λ ) & - sin ( φ )\end{matrix} ]$$

where φ and λ are the latitude and the longitude of the mobile wireless device position (small errors will not have a significant impact on the coefficients of C).

For a state vector \hat{X}ₖ₋₁ at time K−1 and an observation vector \hat{Z}ₖ at time k, the Kalman Filter 208 time update equations are given by:

\hat{X}ₖ⁻−A\hat{X}ₖ₋₁

Pₖ⁻=APₖ₋₁A^{T}+Qₖ,

and the Kalman filter 208 measurement update equations are given by:

rₖ=\hat{Z}ₖ−Hₖ\hat{X}ₖ⁻

Kₖ=Pₖ⁻Hₖ^{T}(HₖPₖ⁻Hₖ^{T}+Rₖ)⁻¹

\hat{X}ₖ=\hat{X}ₖ⁻+Kₖrₖ

Pₖ=(I−KₖHₖ)Pₖ⁻

In the Kalman filter 208 time and measurement update equations,
Pₖ refers to the covariance matrix,
Qₖ refers to the process noise (this is a set of tuneable parameters),
Rₖ refers to the measurement noise (this is a set of tuneable parameters),
Kₖ refers to the Kalman gain, and
Hₖ refers to the observation matrix.
   The observation matrix contains rows corresponding to the available measurements usable by the cooperative positioning system 104 described herein. The matrix A below represents the state evolution, for the state vector definition given here (16 states). One solution uses the following definition (where I is a 4×4 identity matrix):

$$A = [ \begin{matrix}I & Δ t \cdot I & 0 & 0 \\ 0 & I & 0 & 0 \\ 0 & 0 & I & Δ t \cdot I \\ 0 & 0 & 0 & I\end{matrix} ]$$

Kalman filter 208 initialization includes setting initial values for filter parameters. Initial values for P₀, Q₀, and R₀ are tuneable parameters that depend on the specific system design. The elements of the state vector X₀ are initialized based on a position estimate from 5-state WLS estimator 204 or other apriori position information.

The cooperative positioning system 104 computes a delta-altitude measurement with respect to the cooperating mobile wireless devices 102, where Δa is the difference in elevation between the mobile wireless device 102A and the mobile wireless device 102B. Generally, two mobile wireless devices 102 close enough together to obtain a range measurement will have close to the same altitude. Some embodiments of the mobile wireless device 102 include an altimeter that can provide an altitude value used for delta altitude measurements if the mobile wireless devices 102 share the measurements. In some embodiments, a mobile wireless device 102 may assume that it is at the same altitude as the cooperating mobile wireless device.

n_{A}=\sqrt{x_{A}²+y_{A}²+z_{A}²}

n_{B}=\sqrt{x_{B}²+y_{B}²+z_{B}²}

Delta clock bias, Δb, is the difference between the clock biases of the GPS clocks of the cooperating mobile wireless devices 102.

If one of the cooperating mobile wireless devices 102 has a known or estimated location the system of equations is easier to solve. In this case, the mobile wireless device 102 with a known location may or may not also know its clock bias and/or clock drift. For example, the mobile wireless device 102 may know its location by some means other than satellite positioning, and consequently, cannot solve for clock unknowns.

If the handset knows its location, but not its clock bias then its pseudorange measurements may be discarded, and clock bias removed from the list of unknowns unless the application requires the clock bias for both mobile wireless devices 102. For example, some ranging techniques can improve if the relative clock biases of the two mobile wireless devices 102 are known. The same applies to the Doppler frequency measurements and the clock drift state. Some embodiments solve the system in this scenario by treating the known (or estimated) location of the mobile wireless device 102 like a set of three measurements that read directly on the corresponding three states in the system of equations above. This has the benefit that the delta altitude measurement can be used. The number of required satellites is reduced by three in this case.

Alternatively, in some embodiments, the equations are modified as a function of the difference between the states of the cooperating mobile wireless devices 102. The computed difference can be added to the known location of the mobile wireless device 102A to obtain the unknown location of the mobile wireless device 102B. Embodiments apply this solution only if the mobile wireless devices 102 are close to each other because it requires assuming aₓ=bₓ, a_{y}=b_{y}, and a_{z}=b_{z}. One benefit of this method is that the satellite measurements can be differenced to remove common errors. This method is applicable only to satellites for which both mobile wireless devices 102 have measurements.

Some embodiments of the cooperative positioning system 104 synchronize satellite positioning measurements between cooperating mobile wireless devices 102. For example, synchronization may be performed when it is impractical for pseudorange measurements from cooperating mobile wireless devices 102 to be taken at the same time. Some embodiments pass the pseudorange rate measurements and a time-stamp indicating when the pseudorange measurement was taken to the cooperating mobile wireless device 102. Accordingly, the pseudoranges from one mobile wireless device 102 can be adjusted so that they are effectively taken at the same time as the pseudoranges from the other mobile wireless device 102.

The pseudorange is defined as:

$$ρ ( {t}_{2} ) = ρ ( {t}_{1} ) + {\int }_{{t}_{1}}^{{t}_{2}} \dot{ρ} ( x ) d x$$

where \dot{ρ}(t) is the pseudorange rate. In GPS, the pseudorange rate can be assumed to be constant over short durations so that the equation simplifies to:

ρ(t₂)=ρ(t₁)+(t₂−t₁)\dot{ρ}.

Thus, if a time stamp and the pseudorange rate are passed along with the pseudorange between mobile wireless devices 102 a correction is possible. For example, if mobile wireless device 102A took the pseudorange measurement at time t₁ and mobile wireless device 102B took the pseudorange measurement at time t₂, then mobile wireless device 102B can compensate the pseudorange from mobile wireless device 102A for the time delta:

\tilde{ρ}_{A}(t₂)=ρ_{A}(t₁)+(t₂−t₁)\dot{ρ}_{A}.

The time bias between the receivers can be different, causing the time stamps to inaccurately represent the difference in the time the measurements were taken. Some embodiments of the cooperative positioning system 104 address this issue using the clock bias offset computed from the IEEE 802.11v protocol to adjust the delta time:

$${\tilde{ρ}}_{A} ( {t}_{2} ) = {ρ}_{A} ( {t}_{1} ) + ( {t}_{2} - {t}_{1} + \frac{Δ b}{c} ) {\dot{ρ}}_{A} .$$

If the measurements from one device 102 are all delayed by a certain amount, then that delay can be incorporated into that device's clock bias without correcting the measurements themselves. This is an alternative to correcting the measurements as described above that is applicable as long as the other positioning measurements came while the device 102 was at the location from which the satellite measurements were taken.

Embodiments of the cooperative positioning system 104 may apply various techniques to correct the psuedoranges. For example, in addition to the method described above, the well-known solve for time (SFT) algorithm can be applied to pseudorange correction.

In the absence of GPS assistance information, the GNSS receiver 202 decodes the ephemerides of each of the satellites 106 from the received signal. The signal strength required for reliable data demodulation can be as much as 12 dB higher than that required for acquisition/tracking. This reduces the number of satellites that can be used for determining the position of the mobile wireless device 102. However, the signal strength of the visible satellites may differ between two cooperating mobile wireless devices 102. The cooperative positioning system 104 can exploit the difference in signal strength if the satellite ephemeris is shared between the two cooperating mobile wireless devices 102.

Additionally, successful demodulation of the satellite ephemerides can take as much as 30 seconds, severely limiting the time to first fix of a mobile wireless device 102 during autonomous cold start. If one of the mobile wireless devices 102 has already demodulated the satellite ephemerides, sharing this information can also help the other mobile wireless device 102 to reduce its time to first fix.

Embodiments of the mobile wireless device 102 may also apply data-bit wipe-off as another benefit of sharing demodulated data between the mobile wireless devices 102. Data wipe-off for GPS allows longer coherent demodulation which can increase sensitivity. The ephemerides make up a large portion of the data modulated on the GPS signal. However, for complete data-wipe off a mobile wireless device 102 can share all the data that it demodulates for each satellite (of which the ephemeris a subset) with another mobile wireless device 102. Some of the data demodulated across multiple satellites is redundant, so in principle some data compression is possible but not necessary.

The mobile wireless device 102 employs the WLAN transceiver 206 and the associated WLAN 108 to find a suitable partner mobile wireless device 102 with which to cooperate, to measure the distance and clock bias between the cooperating mobile wireless devices 102, and to exchange various positioning measurements between the cooperating mobile wireless devices 102. A suitable partner is a mobile wireless device 102 that supports measurement of distance and clock offset between devices 102. A cooperating mobile wireless device 102 may be stationary or moving. A stationary device may minimize measurement errors. If multiple potential partner devices 102 are available, a mobile wireless device 102 may choose a partner device 102 based on satellite visibility and/or motion of each potential partner device 102. Communication between two devices 102 may be peer-to-peer, through an access point, or through a network server.

Some embodiments of the mobile wireless device 102 determine whether a particular mobile wireless device 102 can support cooperative satellite positioning by sending a Location Configuration Request (LCR) frame, in accordance with the IEEE 802.11 standard, containing a specific message in the Vendor Specific field. If the receiving mobile wireless device 102 does not support this feature it will respond with a failed status, or it will not respond at all. The vendor specific field is defined to make the request in a manner recognized by a viable partner device 102. This technique requires one of the handsets to be a soft access point (AP) since a non-AP cannot configure a station via LCR frames.

Some embodiments of the mobile wireless device 102 employ vendor specific fields in the probe requests defined by the IEEE 802.11 standard to identify suitable partner devices. A mobile wireless device 102 may insert a specific message in the probe request such that if another mobile wireless device 102 processes the message it can obtain the GPS measurements. The GPS measurements may be inserted into the packet itself, or trigger an exchange of information between the mobile wireless devices 102 (per the following options) where the receiving mobile wireless device 102 can use the vendor specific fields in the probe response frame defined by the IEEE 802.11 standard.

Some embodiments of the mobile wireless device 102 seeking a different mobile wireless device 102 for cooperative positioning may broadcast a message delineating the capabilities of the broadcasting device 102 and the desired attributes of a cooperating device 102. Willing partner devices 102 that hear the message may respond with the appropriate messages. The responding mobile wireless device 102 may also send out its own request for information. The broadcast information may be added to an existing beacon frame broadcast to limit the additional network resources used identify cooperating devices 102. The IEEE 802.11 standard allows vendor specific information elements to appear in the beacon frame. In embodiments of the mobile wireless device 102, the vendor specific information elements may carry the positioning measurements disclosed herein.

Thus, LCR frames, probe request/response frames, and/or beacon frames may be used in various ways by embodiments of the mobile wireless device 102 to exchange information used for cooperative positioning. For example, if mobile wireless device 102A broadcasts a request for partner, then the mobile wireless device 102B may respond directly with measurements or respond with an indication of willingness and/or capabilities. Broadcasts may be directed to any listening device 102 or a particular device 102 (e.g., for follow up measurements).

The mobile wireless device 102B may directly respond to the broadcast by providing one or more of pseudoranges, pseudorange rates, and/or ephemerides for tracked satellites, satellite IDs for each measurement, time stamp(s) for pseudorange and pseudorange rate measurements, altimeter measurements, compass measurements, and angle of arrival (AOA) measurements of each satellite. Broadcast and direct responses are supported by vendor specific fields in the IEEE 802.11 standard (e.g., IEEE 802.11v), such as vendor specific fields in the LCR frame, vendor specific fields in probe request/probe response frames, and vendor specific fields in beacon frames. For example, a probe request, broadcast or directed to a specific device 102, may request GPS measurements, and a corresponding probe response may contain the GPS measurements.

A broadcast directed to devices 102 may specify the information requested. For example, a broadcast may request that a receiving device 102 provide: location, list of satellites being tracked, signal to noise ratio of satellites being tracked, number of measurement iterations requested, altimeter measurements, compass measurements, and/or angle of arrival (AOA) measurements for each satellite. A device 102 receiving the broadcast provides a response indicating whether the device is capable and/or willing to provide the information. Such broadcasts and responses are supported by Vendor specific fields in the IEEE 802.11 standard (e.g., IEEE 802.11v), vendor specific fields in probe request/probe response frames, and vendor specific fields in beacon frames. For example, using probe requests/responses, the mobile wireless device 102A transmits a probe request requesting a partner device 102 for cooperative positioning. The mobile wireless device 102B responds via a probe response indicating willingness/capability to cooperate. A subsequent probe request provides or requests satellite positioning measurements. A device 102 that transmits a probe response can thereafter transmit a probe request containing satellite positioning measurements. A wireless device 102A that transmitted a probe request can thereafter transmit more specific requests to the responding device 102B, in accordance with the willingness/capabilities of the device 102B, to which the device 102B responds with satellite measurements. If the mobile wireless device 102A broadcasts via a beacon frame, then the device 102B can respond via a probe request. The device 102A can extract satellite positioning measurements from the probe request and/or provide satellite positioning measurements to the device 102B via a probe response.

Embodiments of the mobile wireless device 102 may advertise availability to participate in cooperative positioning via broadcasts. Such broadcasts may be supported by Vendor specific fields in the IEEE 802.11 standard (e.g., IEEE 802.11v), vendor specific fields in probe request/probe response frames, and/or vendor specific fields in beacon frames. An availability broadcast may include location of the broadcasting device 102, a list of satellites being tracked, number and/or signal to noise ratio of satellites being tracked, altimeter measurements, compass measurements, and/or angle of arrival (AOA) measurements for each satellite. A mobile wireless device 102 may respond to the broadcast with a request for at least some the available information.

Embodiments of the cooperative positioning system 104 can measure the distance and clock offset between two cooperating mobile wireless devices 102 using time of flight measurements and/or received signal strength indicator (RSSI) measurements. The IEEE 802.11v standard specifies a procedure that can be used for measuring both distance and clock offset between two mobile wireless devices 102. Specifically, there is a timing measurement action (TMA) frame that the device 102A may send to the peer device 102B. The protocol is illustrated in FIG. 3. The device 102A requests the TMA frame, then device 102B sends a first packet M, to which the device 102A replies with an acknowledgement (ACK). The device 102B measures the time-of-departure (TOD) of the packet M and the time-of-arrival (TOA) of the acknowledgement. The device 102A measures the TOA of the packet M, and the TOD of the acknowledgement. The device 102B later sends a follow-up packet containing its TOD and TOA measurements (t1 & t4 in the figure). From these the device 102A can compute both the time-of-flight (TOF) and the clock offset (Δb) assuming the channel is symmetric.

t₂−t₁=TOF+Δb

t₄−t₃=TOF−Δb

There are two equations, with two unknowns and four measured values.

$$Δ b = \frac{( {t}_{2} - {t}_{1} ) - ( {t}_{4} - {t}_{3} )}{2}$$

$$TOF = \frac{( {t}_{2} - {t}_{1} ) + ( {t}_{4} - {t}_{3} )}{2}$$

The clocks in the two handsets may have a frequency offset as well so that the relative bias between them changes in time. Embodiments of the cooperative positioning system 104 estimate the frequency offset using multiple TMA frames and calculating the slope of the change in Δb.

The mobile wireless device 102A can also measure RSSI of the mobile wireless device 102B. The mobile wireless device 102A configures the mobile wireless device 102B to transmit a Location Tracking Notification (LTN) frame using a Location Configuration Request (LCR) frame. Subsequently, the mobile wireless device 102B sends packets at the rate it was configured for and containing the configured information. The information includes Radio Information, Motion Information, Time-of-Departure information, & Vendor Specific information. For measuring range the Radio Information is the most important. The path gain from transmitter to receiver can be estimated as:

PG_{dB}(d)=P_{RX}(d)−(P_{TX}+G_{TX}+G_{RX})

where P_{RX}(d) is the received power as a function of the distance traveled, P_{TX} is the transmit power, G_{TX} is the transmit antenna gain, and G_{RX} is the receive antenna gain. The radio information obtained from device 102B contains P_{TX}, and G_{TX} together with knowledge of G_{RX}. Various empirical models may be used to convert from PG_{dB}(d) to d.

Embodiments of the mobile wireless devices 102 may exchange positioning information via a proprietary protocol, and intermediary server, or through adaptation of a WLAN standard. Some embodiments of the mobile wireless devices 102 adapt the IEEE 802.11v standard for exchange of satellite positioning information. The IEEE 802.11v standard defines a protocol that enables the mobile wireless device 102A to configure the mobile wireless device 102B to send positioning information. More specifically, the mobile wireless device 102A configures the mobile wireless device 102B to transmit a Location Tracking Notification (LTN) frame using a Location Configuration Request (LCR) frame. Subsequently, the mobile wireless device 102B sends packets at the configured rate and containing the configured information. The information includes Radio Information, Motion Information, Time-of-Departure information, & Vendor Specific information. Embodiments of the cooperative positioning system 104 populate the vendor specific information with satellite positioning measurements. For example, the vendor specific information may include:
GPS pseudorange measurements with or without ionospheric, orbital, or other corrections.
GPS pseudorange rate measurements.
Satellite IDs for each measurement.
Time GPS measurements were taken (optional). The LCR frame could also specify a specific time at which to take GPS measurements.
   a. If this is not included, the TOD already included in the LTN frame should be as close as possible to the GPS measurement time.
Ephemeris for each satellite (optional).
Other corrective information such as WAAS, or SBAS signals.

In accordance with the IEEE 802.11v standard, the mobile wireless device 102 that implements the configuration cannot be a non-AP. Therefore, one of the cooperating mobile wireless devices 102A, 102B acts as a soft AP for at least the time required to configure the other mobile wireless device 102, and can then revert back to non-AP operation to save power.

In some embodiments, mobile wireless devices 102 establish a tunneled direct link setup (TDLS) connection between the devices 102. Thereafter, the devices 102 can send the vendor specific information mentioned above using a LCR frame. Such operation is not explicitly sanctioned by the IEEE standard, and is therefore a proprietary mode of operation.

Various components of the mobile wireless device 102 including at least some portions of the cooperative positioning system 104 can be implemented using a processor executing software programming that causes the processor to perform the operations described herein. In some embodiments, the cooperative positioning system 104 includes a processor executing software programming that causes the processor to identify a mobile wireless device 102 with which to exchange satellite positioning measurements and focal measurements, to execute measurement exchange, and to determine a position based on satellite and focal measurements originating from all cooperating devices 102. The identification, measurement exchange, and position determination may be performed as disclosed herein.

Suitable processors include, for example, general-purpose microprocessors, digital signal processors, and microcontrollers. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems. Software programming that causes a processor to perform the operations disclosed herein can be stored in a computer readable storage medium. A computer readable storage medium comprises volatile storage such as random access memory, non-volatile storage (e.g., a hard drive, an optical storage device (e.g., CD or DVD), FLASH storage, read-only-memory, or combinations thereof.

Some embodiments can implement portions of the wireless device 102, including portions of the cooperative positioning system 104 using dedicated circuitry (e.g., dedicated circuitry implemented in an integrated circuit). Some embodiments may use a combination of dedicated circuitry and a processor executing suitable software. For example, some portions of the cooperative positioning system 104 may be implemented using a processor or hardware circuitry. Selection of a hardware or processor/software implementation of embodiments is a design choice based on a variety of factors, such as cost, time to implement, and the ability to incorporate changed or additional functionality in the future.

FIG. 4 shows a flow diagram for a method 400 for performing cooperative satellite positioning in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of the method 400, as well as other operations described herein, can be performed by a processor executing instructions stored in a computer readable medium.

In block 402 the mobile wireless device 102A is positioned to view fewer satellites 106 than are needed to determine the location of the device 102A. In order to perform cooperative positioning using positioning measurements derived from satellites 106 not within view of the mobile wireless device 102A, the mobile wireless device 102A identifies other mobile wireless devices 102 with which to cooperate for positioning. For example, the mobile wireless device 102A may transmit, via WLAN 108, a beacon frame or probe request containing a request, in the vendor specific information field, for other mobile wireless devices 102 to provide positioning measurements. The mobile wireless device 102B responds to the request, and is identified as cooperating with the mobile wireless device 102A for positioning.

In block 404, the mobile wireless device 102A and the mobile wireless device 102B share positioning measurements via the WLAN 108. For example the devices 102A, 102B may share satellite pseudoranges, satellite pseudorange rates, satellite identifiers, measurement timestamps, satellite ephemerides, etc. The devices 102A, 102B may also share information from which a focal measurement that is related to both of the devices 102A, 102B may be derived. For example, information from which the distance, relative clock bias, relative bearing, and/or relative altitude between the devices 102A, 102B may be derived is shared. Sharing positioning measurements may include receiving, by the wireless device 102A, positioning measurements provided by the wireless device 102B, and/or providing, by the wireless device 102A, positioning measurements to the wireless device 102B.

In block 406, the mobile wireless device 102A computes an initial position value based on the shared positioning information. In some embodiments of the mobile wireless device 102A, the initial positioning estimate is produced by the 5-state weighted least squares estimator 204. The accuracy of the initial estimate may be low. The Kalman filter 208 is initialized with the initial estimate.

In block 408, the mobile wireless device 102A executes the Kalman filter 208 to converge the location of the device 102A. The Kalman filter 208 may resolve the 16 unknowns of the system of equations disclosed herein to determine the position of the mobile wireless device 102A based on the shared satellite position measurements and one or more of the focal measurements.

In block 410, the mobile wireless device 102A obtains additional satellite positioning measurements from the GNSS receiver 202, and obtains additional information from which new focal measurements may be derived.

In block 412, the mobile wireless devices 102A, 102B share satellite positioning measurements and information related to focal measurements via the WLAN. Sharing positioning measurements may include receiving, by the wireless device 102A, positioning measurements provided by the wireless device 102B, and/or providing, by the wireless device 102A, positioning measurements to the wireless device 102B.

The newly shared information is provided to the Kalman filter 208, and the Kalman filter is executed to further refine the location of the mobile wireless device 102A in block 408.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A mobile wireless device, comprising:
a navigation satellite receiver configured to receive positioning signals from positioning satellites;
a wireless local area network (WLAN) transceiver; and
a cooperative positioning system configured to:
receive positioning measurements from a cooperating mobile wireless device via the WLAN transceiver, the received positioning measurements derived from satellite positioning signals received by the cooperating mobile wireless device;
determine a position of the mobile wireless device based on the positioning measurements received from the cooperating mobile wireless device, positioning measurements provided by the navigation satellite receiver, and a focal measurement that is a function of at least one of the position and the clock bias of both the mobile wireless device and the cooperating mobile wireless device.

2. The mobile wireless device of claim 1, wherein the focal measurement comprises at least one of:
distance between the mobile wireless device and the cooperating mobile wireless device;
relative clock bias between the mobile wireless device and the cooperating mobile wireless device;
relative bearing between the mobile wireless device and the cooperating mobile wireless device; and
relative altitude between the mobile wireless device and the cooperating mobile wireless device.

3. The mobile wireless device of claim 1, wherein the cooperative positioning system comprises a Kalman filter configured to iteratively estimate the position of the mobile wireless device.

4. The mobile wireless device of claim 1, wherein the cooperative positioning system is configured to determine the position of the mobile wireless device based on a system of equations comprising:
$${[ \begin{matrix}{ρ}_{1}^{A} \\ {\dot{ρ}}_{1}^{A} \\ {ρ}_{1}^{B} \\ {\dot{ρ}}_{1}^{B} \\ d \\ {S}_{A} \\ {S}_{B} \\ {\dot{n}}_{A} \\ {\dot{e}}_{A} \\ {\dot{u}}_{A} \\ {\dot{n}}_{B} \\ {\dot{e}}_{B} \\ {\dot{u}}_{B}\end{matrix} ]}_{{[ Δ a ]}_{[ Δ b ]}} = {[ \begin{matrix}{a}_{x} & {a}_{y} & {a}_{z} & 1 & 0 & 0 & 0 & 0 & 0 & 0 & 0 & 0 & 0 & 0 & 0 & 0 \\ {\tilde{a}}_{x} & {\tilde{a}}_{y} & {\tilde{a}}_{z} & 0 & {a}_{x} & {a}_{y} & {a}_{z} & 1 & 0 & 0 & 0 & 0 & 0 & 0 & 0 & 0 \\ 0 & 0 & 0 & 0 & 0 & 0 & 0 & 0 & {b}_{x} & {b}_{y} & {b}_{z} & 1 & 0 & 0 & 0 & 0 \\ 0 & 0 & 0 & 0 & 0 & 0 & 0 & 0 & {\tilde{b}}_{x} & {\tilde{b}}_{y} & {\tilde{b}}_{z} & 0 & {b}_{x} & {b}_{y} & {b}_{z} & 1 \\ {d}_{x} & {d}_{y} & {d}_{z} & 0 & 0 & 0 & 0 & 0 & - {d}_{x} & - {d}_{y} & - {d}_{y} & 0 & 0 & 0 & 0 & 0 \\ 0 & 0 & 0 & 0 & {c}_{A , 1} & {c}_{A , 2} & {c}_{A , 2} & 0 & 0 & 0 & 0 & 0 & 0 & 0 & 0 & 0 \\ 0 & 0 & 0 & 0 & 0 & 0 & 0 & 0 & 0 & 0 & 0 & 0 & {c}_{B , 1} & {C}_{B , 2} & {c}_{B , 3} & 0 \\ 0 & 0 & 0 & 0 & {c}_{A , 11} & {c}_{A , 12} & {c}_{A , 13} & 0 & 0 & 0 & 0 & 0 & 0 & 0 & 0 & 0 \\ 0 & 0 & 0 & 0 & {c}_{A . , 21} & {c}_{A , 22} & {c}_{A , 23} & 0 & 0 & 0 & 0 & 0 & 0 & 0 & 0 & 0 \\ 0 & 0 & 0 & 0 & {c}_{A , 31} & {c}_{A , 32} & {c}_{A , 33} & 0 & 0 & 0 & 0 & 0 & 0 & 0 & 0 & 0 \\ 0 & 0 & 0 & 0 & 0 & 0 & 0 & 0 & 0 & 0 & 0 & 0 & {c}_{B , 11} & {c}_{B , 12} & {c}_{b , 13} & 0 \\ 0 & 0 & 0 & 0 & 0 & 0 & 0 & 0 & 0 & 0 & 0 & 0 & {c}_{B , 21} & {c}_{B , 22} & {c}_{B , 23} & 0 \\ 0 & 0 & 0 & 0 & 0 & 0 & 0 & 0 & 0 & 0 & 0 & 0 & {c}_{B , 31} & {c}_{B , 32} & {c}_{B , 33} & 0\end{matrix} ]}_{{[ \begin{matrix}\frac{{x}_{A}}{{n}_{A}} & \frac{{y}_{A}}{{n}_{A}} & \frac{{z}_{A}}{{n}_{A}} & 0 & 0 & 0 & 0 & 0 & - \frac{{x}_{B}}{{n}_{B}} & - \frac{{y}_{B}}{{n}_{B}} & - \frac{{z}_{B}}{{n}_{B}} & 0 & 0 & 0 & 0 & 0\end{matrix} ]}_{[ \begin{matrix}0 & 0 & 0 & - 1 & 0 & 0 & 0 & 0 & 0 & 0 & 0 & 1 & 0 & 0 & 0 & 0\end{matrix} ]}} [ \begin{matrix}{x}_{A} \\ {y}_{A} \\ {z}_{A} \\ - {b}_{A} \\ {\dot{x}}_{A} \\ {\dot{y}}_{A} \\ {\dot{z}}_{A} \\ - {\dot{b}}_{A} \\ {x}_{B} \\ {y}_{B} \\ {z}_{B} \\ - {b}_{B} \\ {x}_{B} \\ {\dot{y}}_{B} \\ {\dot{z}}_{B} \\ - {\dot{b}}_{B}\end{matrix} ] + {v}_{noise}$$

5. The mobile wireless device of claim 1, wherein the cooperative positioning system comprises a 5-state weighted least squares estimator configured to provide an initial estimate of the location of the mobile wireless device.

6. The mobile wireless device of claim 1, wherein the cooperative positioning system is configured to transmit a message soliciting positioning measurements from the cooperating mobile wireless device in a vendor specific field of at least one of a location configuration request frame, a probe request, and a beacon frame.

7. The mobile wireless device of claim 6, wherein the vendor specific field comprises satellite pseudorange measurements, satellite pseudorange rate measurements, and satellite identification for each measurement.

8. The mobile wireless device of claim 1, wherein one of the mobile wireless device and the cooperating mobile wireless device operate as a soft access point.

9. A method, comprising:
receiving, by a first mobile wireless device, positioning signals transmitted by positioning satellites;
deriving, by the first mobile wireless device, positioning measurements from the positioning signals;
receiving, by the first mobile wireless device, positioning measurements from a second mobile wireless device via a wireless local area network;
determining, by the first mobile wireless device, a position of the first mobile wireless device based on the positioning measurements from the second mobile wireless device, the positioning measurements derived by the first mobile wireless device, and a focal measurement that is a function of at least one of the position and the clock bias of both the first mobile wireless device and the second mobile wireless device.

10. The method of claim 9, further comprising computing the focal measurement as at least one of:
distance between the first mobile wireless device and the second mobile wireless device;
relative clock bias between the first mobile wireless device and the second mobile wireless device;
relative bearing between the first mobile wireless device and the second mobile wireless device; and
relative altitude between the first mobile wireless device and the second mobile wireless device.

11. The method of claim 9, wherein the determining further comprises executing a Kalman filter that iteratively estimates the position of the first mobile wireless device.

12. The method of claim 9, wherein the determining further comprises estimating the position based on a system of equations comprising:
$${[ \begin{matrix}{ρ}_{1}^{A} \\ {\dot{ρ}}_{1}^{A} \\ {ρ}_{1}^{B} \\ {\dot{ρ}}_{1}^{B} \\ d \\ {S}_{A} \\ {S}_{B} \\ {\dot{n}}_{A} \\ {\dot{e}}_{A} \\ {\dot{u}}_{A} \\ {\dot{n}}_{B} \\ {\dot{e}}_{B} \\ {\dot{u}}_{B}\end{matrix} ]}_{{[ Δ a ]}_{[ Δ b ]}} = {[ \begin{matrix}{a}_{x} & {a}_{y} & {a}_{z} & 1 & 0 & 0 & 0 & 0 & 0 & 0 & 0 & 0 & 0 & 0 & 0 & 0 \\ {\tilde{a}}_{x} & {\tilde{a}}_{y} & {\tilde{a}}_{z} & 0 & {a}_{x} & {a}_{y} & {a}_{z} & 1 & 0 & 0 & 0 & 0 & 0 & 0 & 0 & 0 \\ 0 & 0 & 0 & 0 & 0 & 0 & 0 & 0 & {b}_{x} & {b}_{y} & {b}_{z} & 1 & 0 & 0 & 0 & 0 \\ 0 & 0 & 0 & 0 & 0 & 0 & 0 & 0 & {\tilde{b}}_{x} & {\tilde{b}}_{y} & {\tilde{b}}_{z} & 0 & {b}_{x} & {b}_{y} & {b}_{z} & 1 \\ {d}_{x} & {d}_{y} & {d}_{z} & 0 & 0 & 0 & 0 & 0 & - {d}_{x} & - {d}_{y} & - {d}_{y} & 0 & 0 & 0 & 0 & 0 \\ 0 & 0 & 0 & 0 & {c}_{A , 1} & {c}_{A , 2} & {c}_{A , 2} & 0 & 0 & 0 & 0 & 0 & 0 & 0 & 0 & 0 \\ 0 & 0 & 0 & 0 & 0 & 0 & 0 & 0 & 0 & 0 & 0 & 0 & {c}_{B , 1} & {C}_{B , 2} & {c}_{B , 3} & 0 \\ 0 & 0 & 0 & 0 & {c}_{A , 11} & {c}_{A , 12} & {c}_{A , 13} & 0 & 0 & 0 & 0 & 0 & 0 & 0 & 0 & 0 \\ 0 & 0 & 0 & 0 & {c}_{A . , 21} & {c}_{A , 22} & {c}_{A , 23} & 0 & 0 & 0 & 0 & 0 & 0 & 0 & 0 & 0 \\ 0 & 0 & 0 & 0 & {c}_{A , 31} & {c}_{A , 32} & {c}_{A , 33} & 0 & 0 & 0 & 0 & 0 & 0 & 0 & 0 & 0 \\ 0 & 0 & 0 & 0 & 0 & 0 & 0 & 0 & 0 & 0 & 0 & 0 & {c}_{B , 11} & {c}_{B , 12} & {c}_{b , 13} & 0 \\ 0 & 0 & 0 & 0 & 0 & 0 & 0 & 0 & 0 & 0 & 0 & 0 & {c}_{B , 21} & {c}_{B , 22} & {c}_{B , 23} & 0 \\ 0 & 0 & 0 & 0 & 0 & 0 & 0 & 0 & 0 & 0 & 0 & 0 & {c}_{B , 31} & {c}_{B , 32} & {c}_{B , 33} & 0\end{matrix} ]}_{{[ \begin{matrix}\frac{{x}_{A}}{{n}_{A}} & \frac{{y}_{A}}{{n}_{A}} & \frac{{z}_{A}}{{n}_{A}} & 0 & 0 & 0 & 0 & 0 & - \frac{{x}_{B}}{{n}_{B}} & - \frac{{y}_{B}}{{n}_{B}} & - \frac{{z}_{B}}{{n}_{B}} & 0 & 0 & 0 & 0 & 0\end{matrix} ]}_{[ \begin{matrix}0 & 0 & 0 & - 1 & 0 & 0 & 0 & 0 & 0 & 0 & 0 & 1 & 0 & 0 & 0 & 0\end{matrix} ]}} [ \begin{matrix}{x}_{A} \\ {y}_{A} \\ {z}_{A} \\ - {b}_{A} \\ {\dot{x}}_{A} \\ {\dot{y}}_{A} \\ {\dot{z}}_{A} \\ - {\dot{b}}_{A} \\ {x}_{B} \\ {y}_{B} \\ {z}_{B} \\ - {b}_{B} \\ {x}_{B} \\ {\dot{y}}_{B} \\ {\dot{z}}_{B} \\ - {\dot{b}}_{B}\end{matrix} ] + {v}_{noise}$$

13. The method of claim 9, wherein the determining further comprises establishing an initial value for the position of the first mobile wireless device based on a 5-state weighted least squares estimate.

14. The method of claim 9, further comprising transmitting a message soliciting positioning measurements from the second mobile wireless device in a vendor specific field of at least one of a location configuration request frame, a probe request, and a beacon frame.

15. The method of claim 14, wherein the vendor specific field comprises satellite pseudorange measurements, satellite pseudorange rate measurements, and satellite identification for each measurement.

16. The method of claim 9, further comprising configuring at least on of the first mobile wireless device and the second mobile wireless device to operate as a soft access point on the wireless local area network.

17. A wireless device positioning system, comprising:
a processor configured to:
receive satellite positioning measurements from a host wireless device that includes the processor;
receive satellite positioning measurements from a cooperating wireless device;
determine a position of the host wireless device based on the positioning measurements from the cooperating mobile wireless device, the positioning measurements from the host wireless device, and a focal measurement that is a function of at least one of the position and the clock bias of both the host wireless device and the cooperating mobile wireless device.

18. The wireless device positioning system of claim 17, wherein the focal measurement comprises at least one of:
distance between the host wireless device and the cooperating mobile wireless device;
relative clock bias between the host wireless device and the cooperating mobile wireless device;
relative bearing between the host wireless device and the cooperating mobile wireless device; and
relative altitude between the host wireless device and the cooperating mobile wireless device.

19. The wireless device positioning system of claim 17, wherein the processor is further configured to execute a Kalman filter that iteratively estimates the position of the host wireless device.

20. The wireless device positioning system of claim 17, wherein the processor is further configured to determine the position of the host wireless device based on a system of equations comprising:
$${[ \begin{matrix}{ρ}_{1}^{A} \\ {\dot{ρ}}_{1}^{A} \\ {ρ}_{1}^{B} \\ {\dot{ρ}}_{1}^{B} \\ d \\ {S}_{A} \\ {S}_{B} \\ {\dot{n}}_{A} \\ {\dot{e}}_{A} \\ {\dot{u}}_{A} \\ {\dot{n}}_{B} \\ {\dot{e}}_{B} \\ {\dot{u}}_{B}\end{matrix} ]}_{{[ Δ a ]}_{[ Δ b ]}} = {[ \begin{matrix}{a}_{x} & {a}_{y} & {a}_{z} & 1 & 0 & 0 & 0 & 0 & 0 & 0 & 0 & 0 & 0 & 0 & 0 & 0 \\ {\tilde{a}}_{x} & {\tilde{a}}_{y} & {\tilde{a}}_{z} & 0 & {a}_{x} & {a}_{y} & {a}_{z} & 1 & 0 & 0 & 0 & 0 & 0 & 0 & 0 & 0 \\ 0 & 0 & 0 & 0 & 0 & 0 & 0 & 0 & {b}_{x} & {b}_{y} & {b}_{z} & 1 & 0 & 0 & 0 & 0 \\ 0 & 0 & 0 & 0 & 0 & 0 & 0 & 0 & {\tilde{b}}_{x} & {\tilde{b}}_{y} & {\tilde{b}}_{z} & 0 & {b}_{x} & {b}_{y} & {b}_{z} & 1 \\ {d}_{x} & {d}_{y} & {d}_{z} & 0 & 0 & 0 & 0 & 0 & - {d}_{x} & - {d}_{y} & - {d}_{y} & 0 & 0 & 0 & 0 & 0 \\ 0 & 0 & 0 & 0 & {c}_{A , 1} & {c}_{A , 2} & {c}_{A , 2} & 0 & 0 & 0 & 0 & 0 & 0 & 0 & 0 & 0 \\ 0 & 0 & 0 & 0 & 0 & 0 & 0 & 0 & 0 & 0 & 0 & 0 & {c}_{B , 1} & {C}_{B , 2} & {c}_{B , 3} & 0 \\ 0 & 0 & 0 & 0 & {c}_{A , 11} & {c}_{A , 12} & {c}_{A , 13} & 0 & 0 & 0 & 0 & 0 & 0 & 0 & 0 & 0 \\ 0 & 0 & 0 & 0 & {c}_{A . , 21} & {c}_{A , 22} & {c}_{A , 23} & 0 & 0 & 0 & 0 & 0 & 0 & 0 & 0 & 0 \\ 0 & 0 & 0 & 0 & {c}_{A , 31} & {c}_{A , 32} & {c}_{A , 33} & 0 & 0 & 0 & 0 & 0 & 0 & 0 & 0 & 0 \\ 0 & 0 & 0 & 0 & 0 & 0 & 0 & 0 & 0 & 0 & 0 & 0 & {c}_{B , 11} & {c}_{B , 12} & {c}_{b , 13} & 0 \\ 0 & 0 & 0 & 0 & 0 & 0 & 0 & 0 & 0 & 0 & 0 & 0 & {c}_{B , 21} & {c}_{B , 22} & {c}_{B , 23} & 0 \\ 0 & 0 & 0 & 0 & 0 & 0 & 0 & 0 & 0 & 0 & 0 & 0 & {c}_{B , 31} & {c}_{B , 32} & {c}_{B , 33} & 0\end{matrix} ]}_{{[ \begin{matrix}\frac{{x}_{A}}{{n}_{A}} & \frac{{y}_{A}}{{n}_{A}} & \frac{{z}_{A}}{{n}_{A}} & 0 & 0 & 0 & 0 & 0 & - \frac{{x}_{B}}{{n}_{B}} & - \frac{{y}_{B}}{{n}_{B}} & - \frac{{z}_{B}}{{n}_{B}} & 0 & 0 & 0 & 0 & 0\end{matrix} ]}_{[ \begin{matrix}0 & 0 & 0 & - 1 & 0 & 0 & 0 & 0 & 0 & 0 & 0 & 1 & 0 & 0 & 0 & 0\end{matrix} ]}} [ \begin{matrix}{x}_{A} \\ {y}_{A} \\ {z}_{A} \\ - {b}_{A} \\ {\dot{x}}_{A} \\ {\dot{y}}_{A} \\ {\dot{z}}_{A} \\ - {\dot{b}}_{A} \\ {x}_{B} \\ {y}_{B} \\ {z}_{B} \\ - {b}_{B} \\ {x}_{B} \\ {\dot{y}}_{B} \\ {\dot{z}}_{B} \\ - {\dot{b}}_{B}\end{matrix} ] + {v}_{noise}$$

21. The wireless device positioning system of claim 17, wherein the processor is further configured to establishing an initial value for the position of the host wireless device based on a 5-state weighted least squares estimate.

22. The wireless device positioning system of claim 17, wherein the processor is further configured to transmit a message soliciting positioning measurements from the cooperating mobile wireless device in a vendor specific field of at least one of a location configuration request frame, a probe request, and a beacon frame.

23. The wireless device positioning system of claim 22, wherein the wherein the vendor specific field comprises satellite pseudorange measurements, satellite pseudorange rate measurements, and satellite identification for each measurement.
